(19) United States
(12) Patent Application Publication
(10) Pub. No.: US 2018/0373916 A1
(43) Pub. Date: Dec. 27, 2018

(54) FINGERPRINT IDENTIFICATION DEVICE WITH SUPPLEMENTARY LIGHT SOURCE AND MOBILE DEVICE USING THE SAME

(71) Applicant: Eosmem Corporation, Zhubei City (TW)

(72) Inventors: Chu-Hsin CHANG, Zhubei City (TW); Kuan-Yu LIN, Zhubei City (TW)

(21) Appl. No.: 16/014,530

(22) Filed: Jun. 21, 2018

Related U.S. Application Data
(60) Provisional application No. 62/523,482, filed on Jun. 22, 2017.

(51) Int. Cl. G06K 9/00; G06F 1/16

(52) U.S. Cl. CPC G06K 9/0004; G06F 1/1626; G06K 9/00053; G06K 9/00087

(57) ABSTRACT

A fingerprint identification device with supplementary light source and a mobile device using the same are provided in the present invention. The fingerprint identification device includes a substrate, an image sensing integrated circuit and a specific wavelength light-emitting diode (LED). The image sensing integrated circuit disposed on the substrate receives a fingerprint image. The specific wavelength LED is disposed on the substrate in a form of a side view LED package, is coupled to the image sensing integrated circuit, and emits specific wavelength light. A specific wavelength penetrable package mold has a specific angle bevel relative to a horizontal surface of the substrate and reflects the specific wavelength light emitted from a specific wavelength LED die, such that the specific wavelength light is reflected to an upper side relative to the substrate.

This application claims priority to U.S. Provisional Patent Application Ser. No. 62/523,482 filed on Jun. 22, 2017 which is incorporated herein by reference in its entirety.

### BACKGROUND OF THE INVENTION

### Field of the Invention

The invention relates to the technology of fingerprint identification, and more particularly to a fingerprint identification device with a supplementary light source and a mobile device using the same.

### Description of the Related Art

In a general fingerprint identification device, a special wavelength light emitting diode is disposed on a lateral side of an image sensing integrated circuit in order to make the image clearer.

FIG. 1 is a schematic structure view showing a conventional fingerprint identification device. Referring to FIG. 1, the fingerprint identification device includes an image sensing integrated circuit 100, a printed circuit board 101, a substrate 102 and a light emitting diode 103. Also, as shown in the figure, a side view LED package is adopted as the light emitting diode 103 adopts.

FIG. 2 is a schematic view showing optical paths of a conventional side view LED package. Referring to FIG. 2, because most light travelling paths fall on the right side, and the light actually incident to the finger in the upward direction only occupies about 10%, the light often becomes insufficient, so that the fingerprint image sensed by the image sensing integrated circuit becomes unclear.

### BRIEF SUMMARY OF THE INVENTION

The present invention is to provide a fingerprint identification device with a supplementary light source and a mobile device using the same. The supplementary light source is reflected to a finger by a special cut surface so as to increase a signal-to-noise ratio of the fingerprint image of the finger.

In view of this, the invention provides a fingerprint identification device. The fingerprint identification device includes a substrate, an image sensing integrated circuit and a specific wavelength LED. The image sensing integrated circuit is disposed on the substrate, and receives a fingerprint image. The specific wavelength LED includes a specific wavelength LED die and a specific wavelength penetrable package mold. The specific wavelength LED is disposed on the substrate in a form of a side view LED package, is coupled to the image sensing integrated circuit, and emits specific wavelength light. The specific wavelength penetrable package mold has a specific angle bevel relative to a horizontal surface of the substrate, and reflects the specific wavelength light emitted from the specific wavelength LED die, such that the specific wavelength light is reflected to an upper side relative to the substrate.

The invention also provides a fingerprint identification device. The fingerprint identification device includes a printed circuit board, a substrate, an image sensing integrated circuit and a specific wavelength LED. The substrate is disposed on the printed circuit board. The image sensing integrated circuit is disposed on the substrate and receives a fingerprint image. The specific wavelength LED includes a specific wavelength LED die and a specific wavelength penetrable package mold. The specific wavelength LED is disposed on the printed circuit board in a form of a side view LED package, is coupled to the image sensing integrated circuit, and emits specific wavelength light. The specific wavelength penetrable package mold has a specific angle bevel relative to a horizontal surface of the printed circuit board, and reflects the specific wavelength light emitted from a specific wavelength LED die, such that the specific wavelength light is reflected to an upper side relative to the substrate.

The invention further provides a mobile device. The mobile device includes a control circuit, a display panel, a protective cover and a fingerprint identification device. The display panel is electrically connected to the control circuit. The protective cover is disposed on the display panel. The fingerprint identification device includes a substrate, an image sensing integrated circuit and a specific wavelength LED. The image sensing integrated circuit is disposed on the substrate, and receives a fingerprint image. The specific wavelength LED includes a specific wavelength LED die and a specific wavelength penetrable package mold. The specific wavelength LED is disposed on the substrate in a form of a side view LED package, is coupled to the image sensing integrated circuit, and emits specific wavelength light. The specific wavelength penetrable package mold has a specific angle bevel relative to a horizontal surface of the substrate, and reflects the specific wavelength light emitted from the specific wavelength LED die, such that the specific wavelength light is reflected to an upper side relative to the substrate.

The invention further provides a mobile device. The mobile device includes a control circuit, a display panel, a protective cover and a fingerprint identification device. The display panel is electrically connected to the control circuit. The protective cover is disposed on the display panel. The fingerprint identification device includes a printed circuit board, a substrate, an image sensing integrated circuit and a specific wavelength LED. The substrate is disposed on the printed circuit board. The image sensing integrated circuit is disposed on the substrate and receives a fingerprint image. The specific wavelength LED includes a specific wavelength LED die and a specific wavelength penetrable package mold.

The specific wavelength LED is disposed on the printed circuit board in a form of a side view LED package, is coupled to the image sensing integrated circuit, and emits specific wavelength light. The specific wavelength penetrable package mold has a specific angle bevel relative to a horizontal surface of the printed circuit board, and reflects the specific wavelength light emitted from a specific wavelength LED die, such that the specific wavelength light is reflected to an upper side relative to the substrate.

In fingerprint identification device with a supplementary light source and the mobile device using the same according to the embodiment of the present invention, the fingerprint identification device further includes a spatial filter, which is disposed on the image sensing integrated circuit, wherein the spatial filter has adjacent light tunnels, and the light tunnel restricts an incident angle of light to the image sensing integrated circuit to prevent scattered light from entering the image sensing integrated circuit. In a preferred embodiment of the present invention, the light tunnels of the spatial filter constitute a two-dimensional array. Further, In a preferred embodiment of the present invention, the light tunnels of the spatial filter comprise photoresist pillars.

The essence of the invention is to form a bevel on a specific wavelength LED of a side view LED package. Because the refractive indexes of the specific wavelength penetrable package mold of the above-mentioned specific wavelength LED and the air are different from each other, a portion of the specific wavelength light that is emitted to the above-mentioned bevel is totally reflected upwards. In this way, the finger receives more light, and the signal-to-noise ratio of the fingerprint image of the finger is therefore greatly improved.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

FIG. 1 is a schematic structure view showing a conventional fingerprint identification device.

FIG. 2 is a schematic view showing optical paths of a conventional side view LED package.

FIG. 3 is a schematic view showing a mobile device of a preferred embodiment of the invention.

FIG. 4 is a structure diagram showing a fingerprint identification device 304 of a preferred embodiment of the invention.

FIG. 5 is a structure diagram showing the fingerprint identification device 304 of a preferred embodiment of the invention.

FIG. 6 is a structure diagram showing a spatial filter 501 of the fingerprint identification device 304 of a preferred embodiment of the invention.

FIG. 7 is a schematic view showing an operation of the spatial filter 501 of the fingerprint identification device 304 of a preferred embodiment of the invention.

FIG. 8 is a structure diagram showing the fingerprint identification device 304 of a preferred embodiment of the invention.

FIG. 9 is a structure diagram showing the fingerprint identification device 304 of a preferred embodiment of the invention.

FIG. 10A is a graph showing relationships between the brightness and the distance when a cut-surface angle of a specific wavelength LED 403 is equal to 0 degrees.

FIG. 10B is a graph showing relationships between the brightness and the distance when the cut-surface angle of the specific wavelength LED 403 of the fingerprint identification device 304 is equal to 15 degrees in a preferred embodiment of the invention.

FIG. 10C is a graph showing relationships between the brightness and the distance when the cut-surface angle of the specific wavelength LED 403 of the fingerprint identification device 304 is equal to 30 degrees in a preferred embodiment of the invention.

FIG. 10D is a graph showing relationships between the brightness and the distance when the cut-surface angle of the specific wavelength LED 403 of the fingerprint identification device 304 is equal to 45 degrees in a preferred embodiment of the invention.

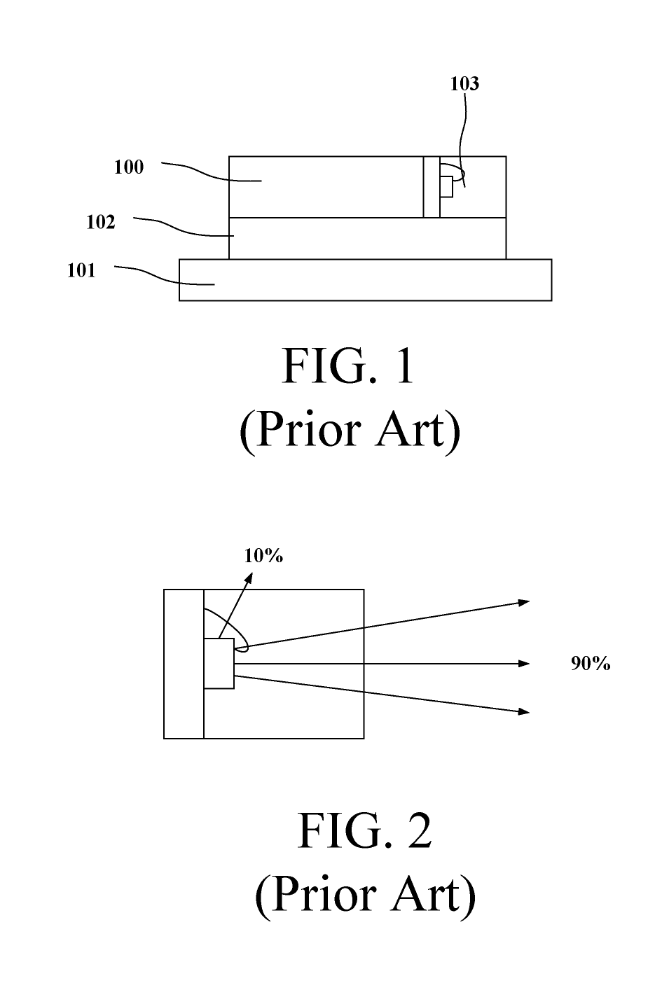

### DETAILED DESCRIPTION OF THE INVENTION

In the embodiments and claims, spatially relative terms, such as “underlying,” “below,” “lower,” “overlying,” “upper” and the like, may be used herein for ease of description to describe one element or feature's relationship to another element(s) or feature(s) as illustrated in the figures. Those skilled in the art may understand that the spatially relative terms are intended to encompass different orientations of the apparatus in use or operation in addition to the orientation depicted in the figures. For example, if an apparatus in the drawing is turned over, elements or features described as “below” or “beneath” other elements or features would then be oriented “above” the other elements. The terms “below” or “beneath” can, therefore, encompass both an orientation of above and below. If the apparatus may be otherwise oriented (rotated 90 degrees or at other orientations), then the spatially relative descriptors used herein may likewise be interpreted accordingly.

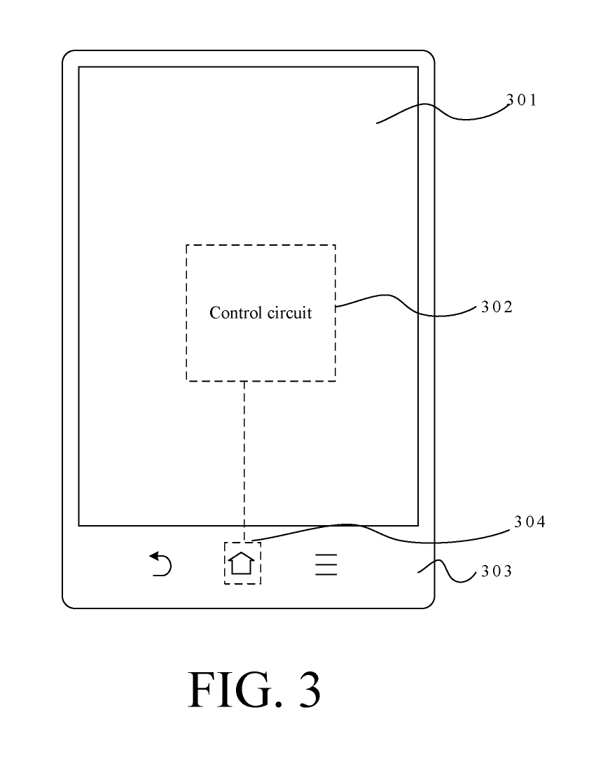

FIG. 3 is a schematic view showing a mobile device of a preferred embodiment of the invention. Referring to FIG. 3, the mobile device in this embodiment includes a display panel 301, a control circuit 302, a cover protection layer 303 and a fingerprint identification device 304 according to the preferred embodiment of the invention. In this embodiment, the cover protection layer 303 is disposed above the display panel, and covers the whole mobile device. The fingerprint identification device 304 is disposed below the cover protection layer 303. Generally speaking, if the current smart mobile phone is taken as an example, then the cover protection layer 303 is implemented by the protective glass. The control circuit 302 is electrically connected to the display panel 301 and the fingerprint identification device 304 to control the display panel 301 and the fingerprint identification device 304. In this embodiment, the fingerprint identification device 304 is disposed on the cover protection layer 303 (i.e., disposed below the protective glass). In addition, in the preferred embodiment, the fingerprint identification device 304 is disposed below a virtual touch button (HOME). In another embodiment, the fingerprint identification device 304 is also disposed below a physical button. Therefore, the invention is not restricted thereto.

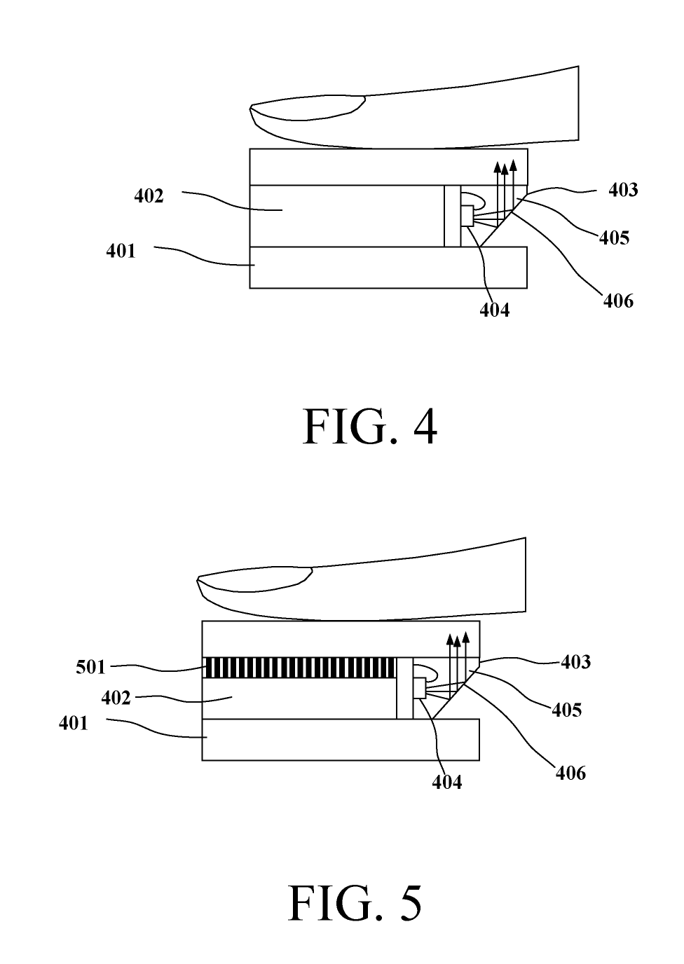

FIG. 4 is a structure diagram showing the fingerprint identification device 304 of a preferred embodiment of the invention. Referring to FIG. 4, the fingerprint identification device includes a substrate 401, an image sensing integrated circuit 402 and a specific wavelength light-emitting diode (LED) 403. The image sensing integrated circuit 402 is disposed on the substrate and receives a fingerprint image. The specific wavelength LED 403 includes a specific wavelength LED die 404 and a specific wavelength penetrable package mold 405. The specific wavelength LED 403 is disposed on the substrate 401 in a form of a side view LED package, is coupled to the image sensing integrated circuit, and emits specific wavelength light. In this embodiment, the specific wavelength light generally refers to the infrared light. However, the general visible light can also function as an embodiment of the invention. Therefore, the invention is not restricted thereto.

In this embodiment, the above-mentioned specific wavelength penetrable package mold has a specific angle bevel 406 relative to a horizontal surface of the substrate. The specific angle bevel 406 can make a portion of the specific wavelength light be totally reflected. Generally speaking, the package mold 405 is an optically denser medium (the medium having a higher refractive index), and the air is an optically thinner medium (the medium having a lower refractive index). When the light enters the optically thinner medium from the optically denser medium and the incident angle is greater than the critical angle, total reflection occurs. Even if the angle of emission is smaller than the critical angle, some light will still be reflected. Since the totally reflected or the reflected specific wavelength of light enters a to-be-sensed object (finger), the upper finger receives most of the specific wavelength light. When the above-mentioned specific wavelength light enters the finger, the above-mentioned specific wavelength light is scattered by the internal tissue of the finger to make the finger's fingerprint become brighter, and the image sensing integrated circuit 402 can sense a clearer fingerprint.

FIG. 5 is a structure diagram showing the fingerprint identification device 304 of a preferred embodiment of the invention. Referring to FIG. 5, in addition to the above-mentioned substrate 401, the above-mentioned image sensing integrated circuit 402 and the above-mentioned specific wavelength LED 403, the fingerprint identification device further includes a spatial filter 501. The spatial filter 501 is disposed on the image sensing integrated circuit 402. In this embodiment, the main function of the spatial filter 501 is to direct the direct light into the image sensing integrated circuit 402, and to block, limit or absorb the scattered light from entering the image sensing integrated circuit 402.

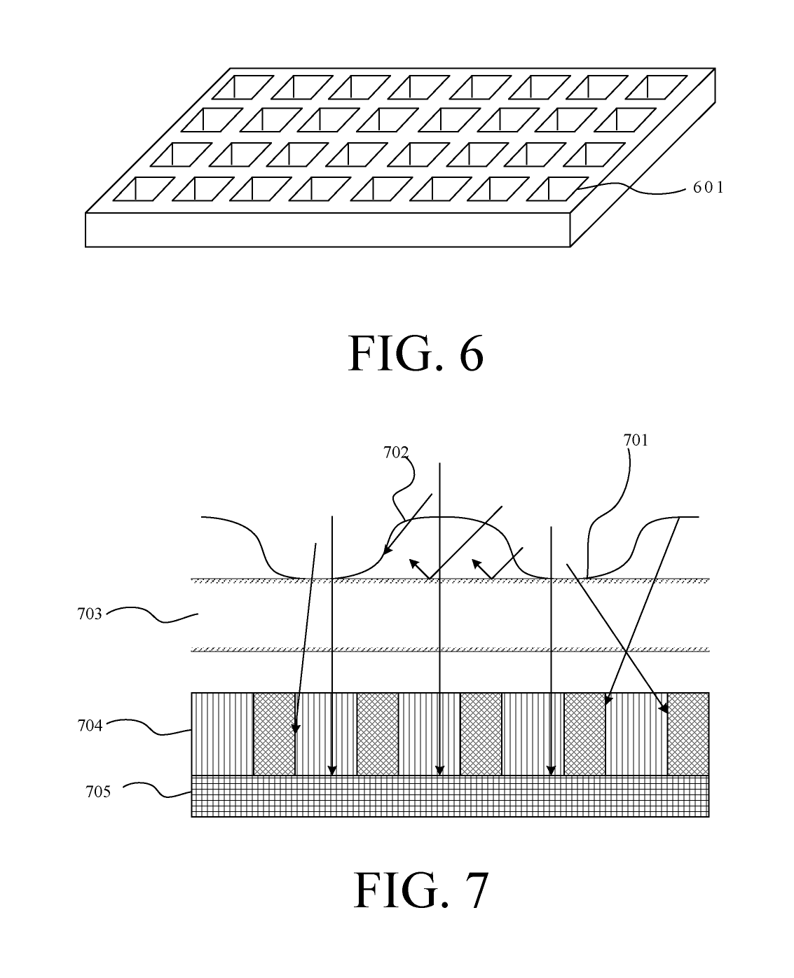

FIG. 6 is a structure diagram showing the spatial filter 501 of the fingerprint identification device 304 of a preferred embodiment of the invention. Referring to FIG. 6, the spatial filter 501 in this embodiment has multiple light tunnels 601, which function to let the direct light enter the image sensing integrated circuit 402, and block, limit or absorb the scattered light from entering the image sensing integrated circuit 402. The light tunnels 601 of the spatial filter 501 have the effect of light absorption, and prevents the scattered light from entering the image sensing members of the image sensing integrated circuit 402. Therefore, the spatial filter 501 has the effect of preventing crosstalk and interference.

FIG. 7 is a schematic view showing an operation of the spatial filter 501 of the fingerprint identification device 304 of a preferred embodiment of the invention. Referring to FIG. 7, symbol 701 represents a ridge portion of the fingerprint; symbol 702 represents a valley portion of the fingerprint; symbol 703 represents the protective glass; symbol 704 represents a spatial filter; symbol 705 represents an image sensing integrated circuit. In the schematic view, it can be seen that the direct light passes through the spatial filter 704 and enters the image sensing integrated circuit 705. The scattered light caused by the valley portion of the fingerprint is reflected by the protective glass and is blocked or absorbed by the non-light tunnel portion of the spatial filter 704. The scattered light caused by the ridge portion of the fingerprint is blocked or absorbed by the non-light tunnel portion of the spatial filter 704. Therefore, the image sensing integrated circuit 705 only receives the light, which is substantially directly incident to the image sensing integrated circuit 705, and does not receive the scattered light, so the image quality of the fingerprint can be improved.

Also, in the semiconductor manufacturing process, in order to manufacture the above-mentioned light tunnels 601 at the time of manufacturing, the photoresist through which the light can pass is used to form the columnar photoresist, which is then covered by the molding material. Therefore, the spatial filter 501 shown in FIG. 6 can be formed. Therefore, in this preferred embodiment, there is a photoresist pillar inside the light tunnel.

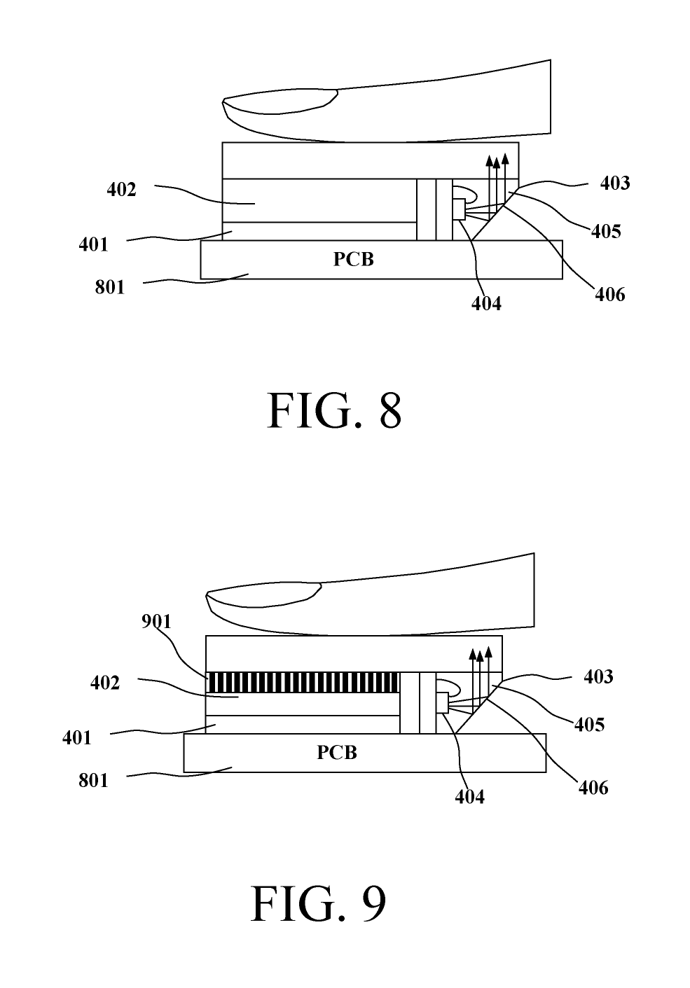

FIG. 8 is a structure diagram showing the fingerprint identification device 304 of a preferred embodiment of the invention. Referring to FIG. 8 of this embodiment, in addition to the substrate 401, the image sensing integrated circuit 402 and the specific wavelength LED 403, the fingerprint identification device further includes a printed circuit board 801. The image sensing integrated circuit 402 is disposed on the substrate and receives the fingerprint image. The specific wavelength LED 403 also includes the specific wavelength LED die 404 and the specific wavelength penetrable package mold 405. The specific wavelength LED 403 is disposed on the printed circuit board 801 in a form of a side view LED package, is coupled to the image sensing integrated circuit 402, and emits specific wavelength light. In this embodiment, the specific wavelength light generally refers to infrared light. However, the general visible light can also function as an embodiment of the invention. Therefore, the invention is not restricted thereto.

FIG. 9 is a structure diagram showing the fingerprint identification device 304 of a preferred embodiment of the invention. Referring to FIG. 9, in addition to the substrate 401, the image sensing integrated circuit 402, the specific wavelength LED 403 and the printed circuit board 801, the fingerprint identification device further includes a spatial filter 901. The spatial filter 901 is disposed on the image sensing integrated circuit 402. Since the functional description and implementation aspect of the spatial filter 901 have already been described in the above-mentioned embodiment, detailed descriptions thereof will be omitted herein.

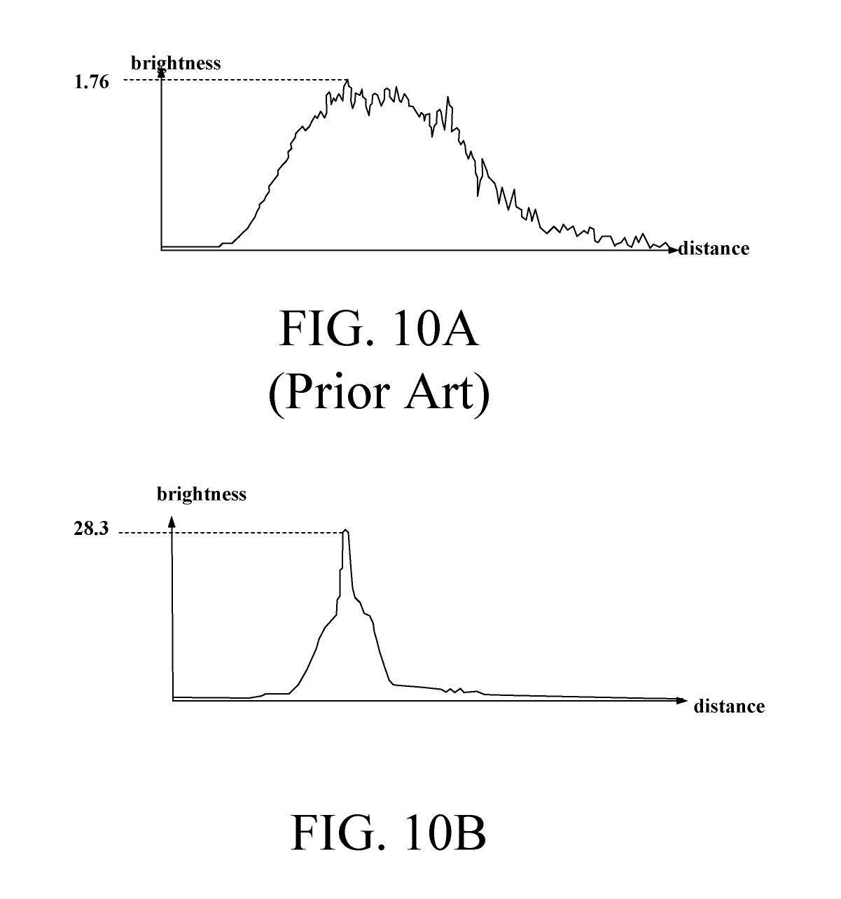

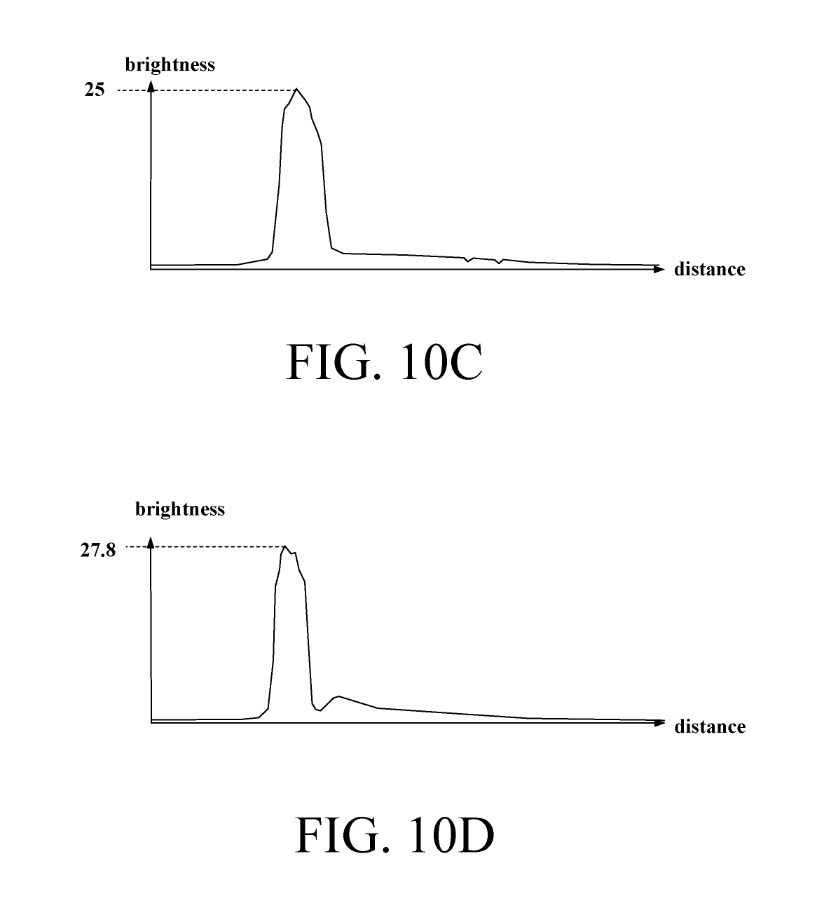

FIG. 10A is a graph showing relationships between the brightness and the distance when a cut-surface angle of the specific wavelength LED 403 is equal to 0 degrees. FIG. 10B is a graph showing relationships between the brightness and the distance when the cut-surface angle of the specific wavelength LED 403 of the fingerprint identification device 304 is equal to 15 degrees in a preferred embodiment of the invention. FIG. 10C is a graph showing relationships between the brightness and the distance when the cut-surface angle of the specific wavelength LED 403 of the fingerprint identification device 304 is equal to 30 degrees in a preferred embodiment of the invention. FIG. 10D is a graph showing relationships between the brightness and the distance when the cut-surface angle of the specific wavelength LED 403 of the fingerprint identification device 304 is equal to 45 degrees in a preferred embodiment of the invention. In FIG. 10A, the specific wavelength LED 403 does not have any cut surface, and although the brightness range is wider, the brightness is only 1.76. In FIG. 10B, the cut-surface angle of the specific wavelength LED 403 is equal to 15 degrees, the brightness range is concentrated, and the brightness is up to 28.3.

In FIG. 10C, the cut-surface angle of the above-mentioned specific wavelength LED 403 is equal to 30 degrees, the brightness range is concentrated, and the brightness is up to 25. In FIG. 10D, the cut-surface angle of the specific wavelength LED 403 is equal to 45 degrees, the brightness range is concentrated, and the brightness is up to 27.8. Therefore, the specific wavelength LED 403 having a cut surface according to the embodiment of the present invention can make the energy of the light become higher and more concentrated, and make the energy of light entering the finger become higher. That is, the signal-to-noise ratio (SNR) of the image detected by the above-mentioned image sensing integrated circuit 402 can be higher.

In summary, the essence of the present invention is to form a bevel on a specific wavelength LED of a side view LED package. Because the refractive indexes of the specific wavelength penetrable package mold of the above-mentioned specific wavelength LED and the air are different from each other, a portion of the specific wavelength light that is emitted to the above-mentioned bevel is totally reflected upwards. In this way, the finger receives more light, and the signal-to-noise ratio of the fingerprint image of the finger is therefore greatly improved.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A fingerprint identification device, comprising:
a substrate;
an image sensing integrated circuit, which is disposed on the substrate and receives a fingerprint image; and
a specific wavelength LED, which comprises a specific wavelength LED die and a specific wavelength penetrable package mold, wherein the specific wavelength LED is disposed on the substrate in a form of a side view LED package, is coupled to the image sensing integrated circuit, and emits specific wavelength light;
wherein the specific wavelength penetrable package mold has a specific angle bevel relative to a horizontal surface of the substrate, and reflects the specific wavelength light emitted from the specific wavelength LED die, such that the specific wavelength light is reflected to an upper side relative to the substrate.

2. The fingerprint identification device according to claim 1, further comprising:
a spatial filter, which is disposed on the image sensing integrated circuit, wherein the spatial filter has adjacent light tunnels, and the light tunnel restricts an incident angle of light to the image sensing integrated circuit to prevent scattered light from entering the image sensing integrated circuit.

3. The fingerprint identification device according to claim 2, wherein the light tunnels of the spatial filter constitute a two-dimensional array.

4. The fingerprint identification device according to claim 2, wherein the light tunnels of the spatial filter comprise photoresist pillars.

5. A fingerprint identification device, comprising:
a printed circuit board;
a substrate disposed on the printed circuit board;
an image sensing integrated circuit, which is disposed on the substrate and receives a fingerprint image; and
a specific wavelength LED comprising a specific wavelength LED die and a specific wavelength penetrable package mold, wherein the specific wavelength LED is disposed on the printed circuit board in a form of a side view LED package, is coupled to the image sensing integrated circuit, and emits specific wavelength light;
wherein the specific wavelength penetrable package mold has a specific angle bevel relative to a horizontal surface of the printed circuit board, and reflects the specific wavelength light emitted from the specific wavelength LED die, such that the specific wavelength light is reflected to an upper side relative to the substrate.

6. The fingerprint identification device according to claim 5, further comprising:
a spatial filter, which is disposed on the image sensing integrated circuit, wherein the spatial filter has adjacent light tunnels, and the light tunnel restricts an incident angle of light to the image sensing integrated circuit to prevent scattered light from entering the image sensing integrated circuit.

7. The fingerprint identification device according to claim 6, wherein the light tunnels of the spatial filter constitute a two-dimensional array.

8. The fingerprint identification device according to claim 6, wherein the light tunnels of the spatial filter comprise photoresist pillars.

9. A mobile device, comprising:
a control circuit
a display panel, electrically connected to the control circuit;
a protective cover, disposed on the display panel; and
a fingerprint identification device, comprising:
a substrate;
an image sensing integrated circuit, which is disposed on the substrate and receives a fingerprint image; and
a specific wavelength LED, which comprises a specific wavelength LED die and a specific wavelength penetrable package mold, wherein the specific wavelength LED is disposed on the substrate in a form of a side view LED package, is coupled to the image sensing integrated circuit, and emits specific wavelength light;
wherein the specific wavelength penetrable package mold has a specific angle bevel relative to a horizontal surface of the substrate, and reflects the specific wavelength light emitted from the specific wavelength LED die, such that the specific wavelength light is reflected to an upper side relative to the substrate.

10. The mobile device according to claim 9, wherein the fingerprint identification device further comprises:
a spatial filter, which is disposed on the image sensing integrated circuit, wherein the spatial filter has adjacent light tunnels, and the light tunnel restricts an incident angle of light to the image sensing integrated circuit to prevent scattered light from entering the image sensing integrated circuit.

11. The mobile device according to claim 10, wherein the light tunnels of the spatial filter constitute a two-dimensional array.

12. The mobile device according to claim 10, wherein the light tunnels of the spatial filter comprise photoresist pillars.

13. A mobile device, comprising:
a control circuit a display panel, electrically connected to the control circuit;
a protective cover, disposed on the display panel; and
a fingerprint identification device, comprising:
a printed circuit board;
a substrate disposed on the printed circuit board;
an image sensing integrated circuit, which is disposed on the substrate and receives a fingerprint image; and
a specific wavelength LED comprising a specific wavelength LED die and a specific wavelength penetrable package mold, wherein the specific wavelength LED is disposed on the printed circuit board in a form of a side view LED package, is coupled to the image sensing integrated circuit, and emits specific wavelength light;
wherein the specific wavelength penetrable package mold has a specific angle bevel relative to a horizontal surface of the printed circuit board, and reflects the specific wavelength light emitted from the specific wavelength LED die, such that the specific wavelength light is reflected to an upper side relative to the substrate.

14. The mobile device according to claim 13, wherein the fingerprint identification device further comprises:
a spatial filter, which is disposed on the image sensing integrated circuit, wherein the spatial filter has adjacent light tunnels, and the light tunnel restricts an incident angle of light to the image sensing integrated circuit to prevent scattered light from entering the image sensing integrated circuit.

15. The mobile device according to claim 14, wherein the light tunnels of the spatial filter constitute a two-dimensional array.

16. The mobile device according to claim 14, wherein the light tunnels of the spatial filter comprise photoresist pillars.
